(19) United States
(12) Patent Application Publication
(10) Pub. No.: US 2014/0050325 A1
(43) Pub. Date: Feb. 20, 2014

(54) MULTI-DIMENSIONAL PARAMETRIC AUDIO SYSTEM AND METHOD

(71) Applicant: ELWOOD Grant NORRIS, Poway, CA (US)

(72) Inventor: ELWOOD Grant NORRIS, Poway, CA (US)

(73) Assignee: Parametric Sound Corporation

(21) Appl. No.: 13/969,292

(22) Filed: Aug. 16, 2013

Related U.S. Application Data
(60) Provisional application No. 61/684,028, filed on Aug. 16, 2012.

(51) Int. Cl. G10L 19/008

(52) U.S. Cl. CPC G10L 19/008
USPC 381/23

(57) ABSTRACT

Systems and methods for producing multi-dimensional parametric audio are provided. The systems and methods can be configured to determine a desired spatial position of an audio component relative to a predetermined listening position; process the audio component for a predetermined number of output channels, wherein the step of processing the audio component comprises determining the appropriate phase, delay, and gain values for each output channel so that the audio component is created at the desired apparent spatial position relative to the listening position; encode two or more output channels of the audio component with the determined phase, delay, and gain values for each output channel; and modulate the encoded output channels onto respective ultrasonic carriers for emission via a predetermined number of ultrasonic emitters

### REFERENCE TO RELATED APPLICATIONS

This application claims priority to U.S. Provisional Patent Application No. 61/684,028, filed Aug. 16, 2012, the contents of which is incorporated herein by reference in its entirety.

### TECHNICAL FIELD

The present invention relates generally to audio systems, and more particularly, some embodiments relate to multi-dimensional audio processing for ultrasonic audio systems.

### BACKGROUND OF THE INVENTION

Surround sound or audio reproduction from various positions about a listener can be provided using several different methodologies. One technique uses multiple speakers encircling the listener to play audio from different directions. An example of this is Dolby® Surround Sound, which uses multiple speakers to surround the listener. The Dolby 5.1 process digitally encodes five channels (plus subwoofer) of information onto digital bitstream. These are the Left Front, Center Front, Right Front, Surround Left, and a Surround Right. Additionally, a Subwoofer output is included (which is designated by the “.1”). A stereo amplifier with Dolby processing receives the encoded audio information and decodes the signal to derive the 5 separate channels. The separate channels are then used to drive five separate speakers (plus a subwoofer) placed around the listening position.

Dolby 6.1. and 7.1 are extensions of Dolby 5.1. Dolby 6.1 includes a Surround Back Center channel. Dolby 7.1 adds left and right back speakers that are preferably placed behind the listening position and the surround speakers are set to the sides of the listening position. An example of this is provided in FIG. 1, below. Referring now to FIG. 1, the conventional 7.1 system includes Left Front (LF), Center, Right Front (RF), Left Surround (LS), Right Surround (RS) Back Surround Left (BSL) and Back Surround Right (BSR). Additionally, a Subwoofer, or Low Frequency effects (LFE), is shown.

Upon playback, the decoders at the audio amplifier decode the encoded information in the audio stream and break up the signal into its constituent channels—e.g., 7 channels plus a subwoofer output for 7.1. The separate channels are amplified and sent to their respective speakers. One downside of 7.1 and other multi-speaker surround sound systems is that they require more than two speakers, and that the speakers be placed around the listening environment. These requirements can lead to increased cost, additional wiring and practical difficulties with speaker placement.

Additionally, the sound created by the conventional speakers is always produced on the face of the speaker (i.e., at the speaker cone). The sound wave created at the surface propagates through the air in the direction at which the speaker is pointed. In simplest terms, the sound will appear to be closer or farther away from the listener depending on how far away from the listener the speaker is positioned. The closer the listener is to the speaker, the closer the sound will appear. The sound can be made to appear closer by increasing the volume, but this effect is limited.

In a surround sound speaker system using conventional speakers, speakers may be placed to ‘surround’ the listener, but it is apparent that the sound is produced at discrete points along the perimeter corresponding to the position of the speakers. This is apparent when listening to content in a surround-sound environment. In such environments, the sound can appear to move from one speaker to another, but it always sounds like its source is the speaker itself—which it is. Phasing can have the effect of blending sound between speakers, but conventional surround sound systems cannot achieve placement or apparent placement of sound in the environment at determined distances from a listener or listening location.

Moreover, even this limited ‘surround’ effect cannot be achieved with only a pair conventional speakers. Introducing audio processing effects to a two-channel (Left/Right) system can allow the sound to appear to move from the left speaker to the right speaker, but the sound cannot be placed at a desired distance from or beyond the listener.

Monaural and Stereo playback has been achieved using non-linear transduction through a parametric array. Non-linear transduction, such as a parametric array in air, results from the introduction of audio-modulated ultrasonic signals into an air column. Self-demodulation, or down-conversion, occurs along the air column resulting in the production of an audible acoustic signal. This process occurs because of the known physical principle that when two sound waves of sufficient intensity with different frequencies are radiated simultaneously in the same medium, a modulated waveform including the sum and difference of the two frequencies is produced by the non-linear (parametric) interaction of the two sound waves. When the two original sound waves are ultrasonic waves and the difference between them is selected to be an audio frequency, an audible sound can be generated by the parametric interaction.

While the theory of non-linear transduction has been addressed in numerous publications, commercial attempts to capitalize on this intriguing phenomenon have largely failed. Most of the basic concepts integral to such technology, while relatively easy to implement and demonstrate in laboratory conditions, do not lend themselves to applications where relatively high volume outputs are necessary. As the technologies characteristic of the prior art have been applied to commercial or industrial applications requiring high volume levels, distortion of the parametrically produced sound output has resulted in inadequate systems.

### BRIEF SUMMARY OF THE DISCLOSURE

According to various embodiments of the disclosed methods and systems, multi-dimensional audio processing is provided for ultrasonic audio systems. In one embodiment, a parametric audio encoder in an audio system is configured to determine a desired spatial position of an audio component relative to a predetermined listening position; process the audio component for a predetermined number of output channels; encode two or more output channels of the audio component; and modulate the encoded output channels onto respective ultrasonic carriers for emission via a predetermined number of ultrasonic emitters.

In one embodiment, processing the audio component includes determining the appropriate phase, delay, and gain values for each output channel so that the audio component is created at the desired apparent spatial position relative to the listening position. In this embodiment, encoding the two or more output channels is done using the determined phase, delay, and gain values for each output channels.

In one embodiment, processing the audio component further includes determining echo, reverb, flange, and phasor values. In this embodiment, encoding the output channels may further include encoding two or more output channels with the determined echo, reverb, flange, and phasor values.

In another embodiment, processing the audio component further includes determining the appropriate phase, delay, and gain values for each output channel based on a predetermined location of the each of the predetermined number of ultrasonic emitters.

In yet another embodiment, the audio system may be further configured to receive an encoded audio source comprising an audio component, wherein the audio source is encoded with component positioning information that relates to the spatial position of the audio component. In this embodiment, the encoded audio source may include a plurality of audio components may be encoded with information that relates to the spatial position of each audio component of the plurality of audio components. The audio system may be further configured to decode the encoded audio source to obtain each audio component of the plurality of audio components and the information that relates to the spatial position of each audio component.

Other features and aspects of the disclosed method and apparatus will become apparent from the following detailed description, taken in conjunction with the accompanying drawings, which illustrate, by way of example, the features in accordance with embodiments of the disclosure. The summary is not intended to limit the scope of the claimed disclosure, which is defined solely by the claims attached hereto.

### BRIEF DESCRIPTION OF THE DRAWINGS

FIG. 1 illustrates the conventional Dolby® Surround Sound configuration, with components for Dolby 5.1, 6.1, or 7.1 configurations.

FIG. 2 illustrates an example encoding and decoding process in accordance with various embodiments of the technology described herein.

FIG. 3 is a flow diagram of the method of creating a parametric audio signal from a previously signal encoded for use in a conventional surround sound system in accordance with various embodiments of the technology described herein.

FIG. 4 is a flow diagram of the method of encoding an audio component to produce a parametric audio signal in accordance with various embodiments of the technology described herein.

FIG. 5A illustrates an example embodiment of the invention where ultrasonic emitters direct the parametric audio signal directly towards either the left or right sides of a particular listening position.

FIG. 5B illustrates an example embodiment of the invention where ultrasonic emitters reflect the parametric audio signal off a wall.

FIG. 6 illustrates an example embodiment of a hybrid embodiment where the method of parametric audio production and ultrasonic emitters in accordance with embodiments of the invention is combined with a conventional surround sound configuration.

FIG. 7 illustrates an example computing module that may be used in implementing various features of embodiments of the technology described herein.

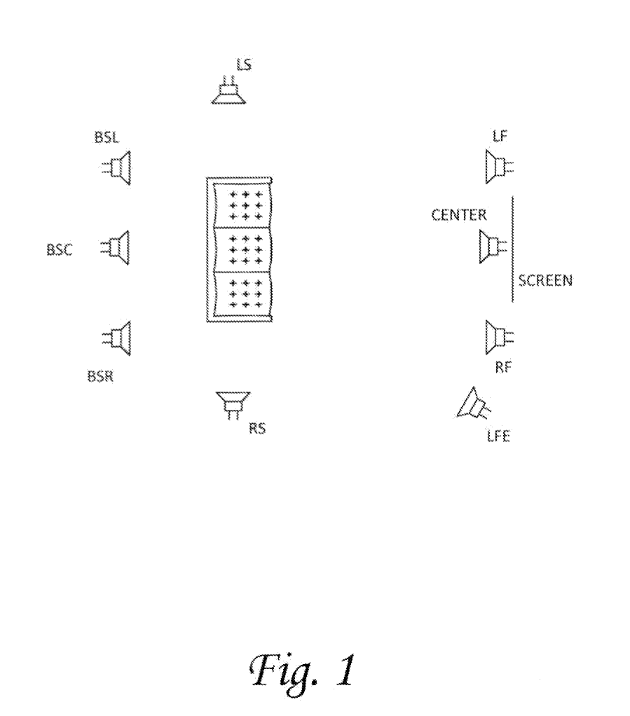

### DESCRIPTION OF EMBODIMENTS OF THE INVENTION

Embodiments of the systems and methods described herein provide multidimensional audio or a surround sound listening experience using as few as two emitters.

According to various embodiments of the systems and methods described herein, various components of the audio signal can be processed such that the signal played through ultrasonic emitters creates a three-dimensional sound effect. In various embodiments, a three-dimensional effect can be created using only two channels of audio, thereby allowing as few as two emitters to achieve the effect. In other embodiments, other quantities of channels and emitters are used.

With ultrasonic audio systems, the ultrasonic transducers, or emitters, that emit the ultrasonic signal can be configured to be highly directional. Accordingly, a pair of properly spaced emitters can be positioned such that one of the pair of emitters targets one ear of the listener or a group of listeners, and the other of the pair of emitters targets the other ear of the listener or group of listeners. The targeting can but need not be exclusive. In other words, sound created from an emitter directed at one ear of the listener or group of listeners can ‘bleed’ over into the other ear of the listener or group or listeners.

This can be thought of as similar to the way a pair of stereo headphones targets each ear of the listener. However, using the audio enhancement techniques described herein and ultrasonic emitters targeting each ear, a greater degree of spatial variation can be accomplished than is achieved with conventional headphones or speakers. Headphones, for example, only allow control of the sound to the left and right sides of the listener and can blend sound in the center. They cannot provide front or rear placement of the sound. As noted above, surround sound systems using conventional speakers positioned around the listening environment can provide sources to the front of, sides of and behind the listener, but the sources of that sound are always the speakers themselves.

According to various embodiments described herein, adjusting the parameters of the signal, frequency components of the signal, or other signal components on the two ultrasonic channels (more channels can be used) relative to each other—such as the phase, delay, gain, reverb, echo, or other audio parameters—allows the audio reproduction of that signal or of component(s) within that signal, to appear to be positioned at a predetermined or desired location in the space about the listener(s). With ultrasonic emitters and ultrasonic-carrier audio, the audio can be generated by demodulation of the ultrasonic carrier in the air between the ultrasonic emitter and the listener (sometimes referred to as the air column). Accordingly, the actual sound is created at what is effectively an infinite number of points in the air between the emitter and the listener and beyond the listener. Therefore, in various embodiments these parameters are adjusted to emphasize an apparent sound generated at a chosen location in space along the column. For example, the sound created (e.g., for a component of the audio signal) at a desired location can be made to appear to be emphasized over the sound created at other locations. Accordingly, with just one pair of emitters (e.g., a left and right channel), the sound can be made to appear to be generated at a point along one of the paths from the emitter to the listener at a point closer to or farther from the listener, whether in front of or behind the listener. The parameters can also be adjusted so that sound appears to come from the left or right directions at a predetermined distance from the listener. Accordingly, two channels can provide a full 360 degree placement of a source of sound around a listener, and at a chosen distance from the listener. As also described herein, different audio components or elements can be processed differently, to allow controlled placement of these audio components at their respective desired locations within the channel.

Adjusting the audio on two or more channels relative to each other allows the audio reproduction of that signal or signal component to appear to be positioned in space about the listener(s). Such adjustments can be made on a component or group of components (e.g., Dolby or other like channel, audio component, etc.) or on a frequency-specific basis. For example, adjusting phase, gain, delay, reverb, and echo, or other audio processing of a single signal component, can also allow the audio reproduction of that signal component to appear to be positioned in a predetermined location in space about the listener(s). This can include apparent placement in front of or behind the listener.

Additional auditory characteristics, such as, for example, sounds captured from auditorium microphones placed in the recording environment (e.g., to capture hall or ambient effects), may be processed and included in the audio signal (e.g., blending with one or more components) to provide more realism to the three-dimensional sound. In addition to adjusting the parameters on a component or element basis, the parameters can be adjusted based on frequency components.

Preferably, in one embodiment, various audio components are created with a relative phase, delay, gain, echo and reverb or other effects built into the audio component such that can be placed in spatial relation to the listening position upon playback. For example, computer synthesized or computer-generated audio components can be created with or modified to have signal characteristics to allow placement of various audio components and their desired respective positions in the listening environment. As described above, the Dolby (or other like) components can be modified to have signal characteristics to allow apparent placement of various audio components and their desired respective positions in the listening environment.

As a further example, consider a computer-generated audio/video experience such as a videogame. In the 3-D gaming experience, the user is typically immersed into a world with the gaming action occurring around the user in that world in three dimensions. For example, in a shooting game or other war simulation game, the gamer may be in a battlefield environment that includes aircraft flying overhead, vehicles approaching from or departing to locations around the user, other characters sneaking up on the gamer from behind or from the side, gunfire at various locations around the player, and so on. As another example, consider an auto racing game where the gamer is in the cockpit of the vehicle. He or she may hear engine noise from the front, exhaust noise from the rear, tires squealing from the front or rear, the sounds of other vehicles behind, to the side and front of the gamer's vehicle, and so on.

Using a traditional surround sound speaker system, multiple speakers would be required, and the player would be able to tell the general direction from which the sound is emanating within the confines of the system, but would not be fully immersed in the 3D environment. It would be apparent that the sound is produced at a discrete point around the perimeter of the listening field, and the sound cannot be made to appear to emanate from points closer to or farther from the listener. The sound only appears closer or farther away based on the strength of the signal at the listening point. For example, the player could tell that a particular sound came from the right side, but could not discern the actual distance—right beside the player, at the wall, etc. How dose the object seemed would depend on the strength of the signal at the player's position, determined by the relative volumes of the speakers. However, this effect is limited, and adjusting relative volume alone does not necessarily provide. For example, changing the volume can give the appearance that distance is changing. However, in real world environments, volume alone is not the only factor used to judge distance. The character of a given sound beyond its volume changes as the source of the given sound moves farther away. The effects of the environment are more pronounced, for example.

Using the system and methods herein described, not only would the player be able to discern the direction of the sound but also the location from which the sound emanates in a three-dimensional environment. Moreover, this can be done with just two emitters. If the audio sound were a person positioned about 3 feet in front of the player and 5 feet to the left, the player would be able to determine where the sound came from. This is because the sound is created at specific spatial positions in the air column, not on the speaker face as is the case with traditional speakers. Changing the audio parameters discussed above can cause the sound to appear as if it is being created at (or in the vicinity of) that location 3 feet in front of the and 5 feet to the left of the player (or viewer/listener). An increase in volume would be equivalent to a person raising their voice—although what was said may be clearer, it does not necessarily sound closer. By using non-linear transduction as described above with the methods and system described herein, it is possible to create a three-dimensional audio experience, whereby sound actually created at one or more locations along the air column can be emphasized to place the source at those locations. Therefore, spatial positioning of a particular sound may be accomplished.

By adding phase change, gain, phasor, flange, reverb and/or other effects to each of these audio objects, and by playing the audio content to the gamer using parametric sound through directional ultrasonic transducers, the user can be immersed in a three-dimensional audio experience using only two “speakers” or emitters. For example, increasing the gain of an audio component on the left channel relative to the right, and at the same time adding a phase delay on that audio component for the right channel relative to the left, will make that audio component appear to be positioned to the left of the user. Increasing the gain or phase differential (or both) will cause the audio component to appear as if it is coming from a position farther to the left of the user.

Different levels of this audio processing can be applied to different audio components to place each audio component properly in the environment. For example, when a game character in the game is approaching the user, each footstep of that character may be encoded differently to reflect that footstep's position relative to the prior or subsequent footsteps of that character. Thus applying different processing to each subsequent footstep audio component, the footsteps can be made to sound like they are moving toward the gamer from a predetermined location or moving away from the gamer to a predetermined position. Additionally, the volume of the footstep sound components can be likewise adjusted to reflect the relative distance of the footsteps as they approach or move away from the user.

Thus, a sequence of audio components that make up an event (such as footsteps of an approaching character) can be created with the appropriate phase, gain, or other difference to reflect relative movement. Likewise, the audio characteristics of a given audio component can be altered to reflect the changing position of the audio component. For example, the engine sound of the overtaking vehicle can be modified as the vehicle overtakes the gamer to positioned sound properly in the 3-D environment of the game. This can be in addition to any other alteration of the sound such as, for example, to add Doppler effects for additional realism. Likewise, additional echo can be added for sounds that are farther away, because as an object gets closer, its sound tends to drown out its echo.

These techniques an also be used to provide a surround sound experience with surround sound encoded audio signals using only two “speakers” or emitters. For example, various embodiments, a two-channel audio signal that has been encoded with surround sound components can be decoded to its constituent parts, the constituent parts be re-encoded according to systems and methods described herein to provide correct spatial placement of the audio components and recombined into a two-channel audio signal for playback using two ultrasonic emitters.

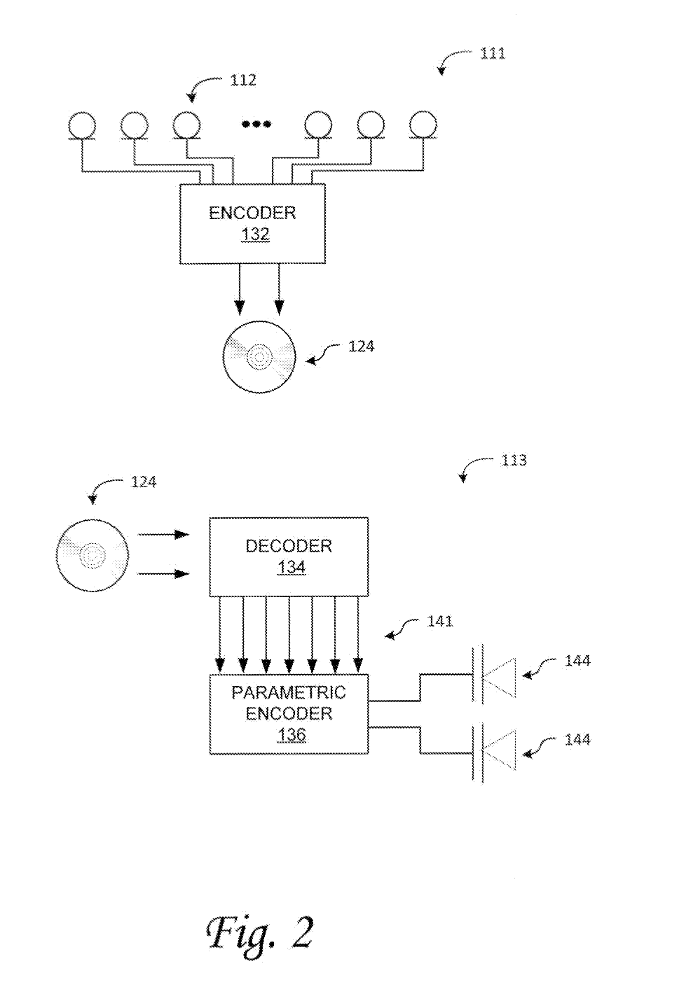

FIG. 2 is a diagram illustrating an example of a system for generating two-channel, multidimensional audio from a surround-sound encoded signal in accordance with one embodiment of the systems and methods described herein. Referring now to FIG. 2, the example audio system includes an audio encoding system 111 and an example audio playback system 113. The example audio encoding system 111 includes a plurality of microphones 112, an audio encoder 132 and a storage medium 124.

The plurality of microphones 112 can be used to capture audio content as it is occurring. For example, a plurality of microphones can be placed about a sound environment to be recorded. For example, for a concert a number of microphones can be positioned about the stage or within the theater to capture sound as it is occurring at various locations in the environment. Audio encoder or surround sound encoder 132 processes the audio received from the different microphone input channels to create a two channel audio stream such as, for example, a left and right audio stream. This two-channel audio stream encoded with information for each of the tracks or microphone input channels can be stored on any of a number of different storage media 124 such as, for example, flash or other memory, magnetic or optical discs, or other suitable storage media.

In the example described above with reference to FIG. 2, signal encoding from each microphone is performed on a track-by-track basis. That is, the location or position information of each microphone is preserved during the encoding process such that during subsequent decoding and re-encoding (described below) that location or position information affects the apparent position of the audio playback signal components. In other embodiments, encoding performed by audio encoder 132 separates the audio information into tracks that are not necessarily tied to, or that do not necessarily correspond on a one-to-one basis with each of the individual microphones 112. In other words, audio components can be separated into various channels such as center front, left front, right front, left surround, right surround, left back surround, right back surround, and so on based on content rather than based on which microphone was used to record the audio. An example of audio encoder is used to create multiple tracks of audio information encoded onto a two track audio stream is a Dolby Digital or Dolby surround sound processor. In this example, the audio recording generated by audio encoder 132 can store one storage medium 124 can be, for example, a Dolby 5.1 or 7.1 audio recording. In addition to recording the audio information, the content can be synthesized and assembled using purely synthesized sound or a combination of synthesized and recorded sounds.

In the example illustrated in FIG. 2 to reproduce the audio content in the listening environment, a decoder 134 and parametric encoder 136 are provided in the reproduction system 113. As illustrated in this example, the encoded audio content (in this case stored on media 124) 62-channel encoded audio content created by audio encoding system 111. Decoder 134 is used to decode the encoded two-channel audio stream into the multiple different surround sound channels 141 that make up the audio content. For example, in an embodiment where multiple microphones 112 are used to record multiple channels of audio content, coder 134 can re-create an audio channel 141 for each microphone channel 112. As another example, in the case of Dolby encoded audio content, coder 134 can be implemented as a Dolby decoder and the surround sound channels 141 are the re-created surround sound speaker channels (e.g., left front, center, right front, and so on).

Parametric encoder 136 and be implemented as described above to split each surround sound channel 141 into a left and right channel, and to apply audio processing (in the digital or analog domain) to position the sound for each channel at the appropriate position in the listening environment. As described above, such positioning can be accomplished by adjusting the phase, delay, gain, echo, reverb and other parameters of the left channel relative to the right channel or of both channels simultaneously for a given surround sound effect. This parametric encoding for each channel can be performed on each of the surround sound channels 141, and the left and right components of each of the surround sound channels 141 combined into a composite left and right channel for reproduction by ultrasonic emitters 144. With such processing, the surround sound experience can be produced in a listening environment using only two emitters (i.e., speakers), rather than requiring 5-7 (or more) speakers placed about the listening environment.

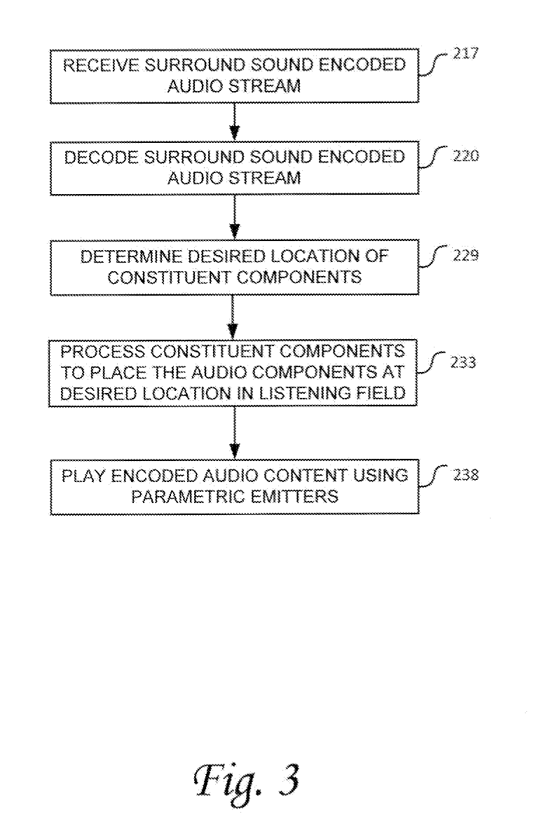

FIG. 3 is a diagram illustrating an example process for generating multi-dimensional audio content in accordance with one embodiment of the systems and methods described herein. Referring now to FIG. 3, in a step 217, surround sound encoded audio content is received, in the form of an audio bitstream. For example, a two-channel Dolby encoded audio stream can be received from a program source such as, for example, a DVD, Blu-Ray Disk, or other program source. At step 220, the surround-sound encoded audio stream is decoded, and the separate channels are available for processing. In various embodiments, this can be done using conventional Dolby decoding that separates an encoded audio stream into the various individual surround channels. This can be done in the digital or analog domains, and the resulting audio streams for each channel can include digital or analog audio content. At step 229, the desired location of these channels is identified or determined. In other words, for example, in terms of a Dolby 7.1 audio content, the desired position for the audio for each of the left front, center front, right front, left surround, right surround, back left surround and back right surround channels is determined. A digitally encoded Dolby bitstream can be received, for example, from a program source such as DVD, BlueRay, other audio program source.

At step 233, the channels are processed to “place” each audio channel at the desired location in the listening field. For example, in terms of the embodiment described above, each channel is divided into two channels (for example, a left and a right channel) the appropriate processing applied provide spatial context for the channel. In various embodiments, this can involve adding a differential phase shift, gain, echo, reverb, and other audio parameter to each channel relative to the other for each of the surround channels to effectively place the audio content for that channel at the desired location in the listening field. In some embodiments, for the center front channel, no phase or gain differentials are applied to the left and right channels so that the audio appears to be coming from between the two emitters. At step 238, the audio content is played through the pair of parametric emitters.

In some embodiments, parametric processing is performed with the assumption that the pair of parametric emitters will be placed like conventional stereo speakers—i.e, in front of the listener and separated by distance to the left and right of the center line from the listener. In other embodiments, processing can be performed to account for placement of the parametric emitters at various other predetermined locations in the listening environment. By adjusting parameters such as the phase and gain of the signal being sent to one emitter relative to the signal being sent to the other emitter, placement of the audio content can be achieved at desired locations given the actual emitter placement.

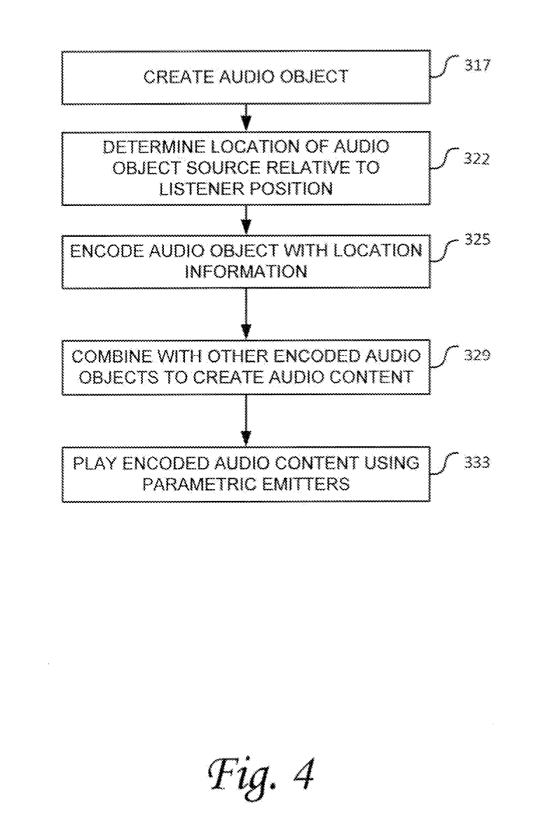

FIG. 4 is a diagram illustrating an example process for generating and reproducing multidimensional audit content using parametric emitters in accordance with one embodiment of the systems and methods described herein. An example application for the process shown in the embodiment of FIG. 4 is an application in the video game environment. In this example application, various audio objects are created with their positional or location information already built in or embedded such that when played through is a pair of parametric emitters, the sound of each audio object appears to be originating from the predetermined desired location.

Referring now to FIG. 4, at step 317 an audio object is created. In the example of the video game environment, an audio object can be any of a number of audio sounds or sound clips such as, for example, a footstep, a gunshot, a vehicle engine, or a voice or sound of another character, just to name a few. At step 322 the developer determines the location of the audio object source relative to the listener position. For example at any given point in a war game, the game may generate the sound of gunfire (or other action) emanating from a particular location. For example, consider the case of gunfire originating from behind and to the left of the gamer's current position. With this known position, at step 325 the audio object (gunfire in this example) is encoded with the location information such that when it is played to the earner using the parametric emitters, the sound appears to emanate from behind and to the left of the gamer. Accordingly, when the audio object is created, it can be created as an audio object having two channels (e.g., left and right channels) with the appropriate phase and gain differentials, and other audio characteristics, to cause the sound to appear to be emanating from the desired locations.

In some embodiments, the sound can be prestored as library objects with the location information or characteristics already embedded or encoded therein such that they can be called from the library and used as is. In other embodiments, generic library objects are stored for use, and when called for application in a particular scenario are processed to apply the position information to the generic object. Continuing with the gunfire example, in some embodiments gunfire sounds from a particular weapon can be stored in a library and, when called, processed to add the location information to the sound based on where the gunfire is to occur relative to the gamer's position.

At step 329, the audio components with the location information are combined to create the composite audio content, and at step 333 the composite audio content is played to the user using the pair of parametric emitters.

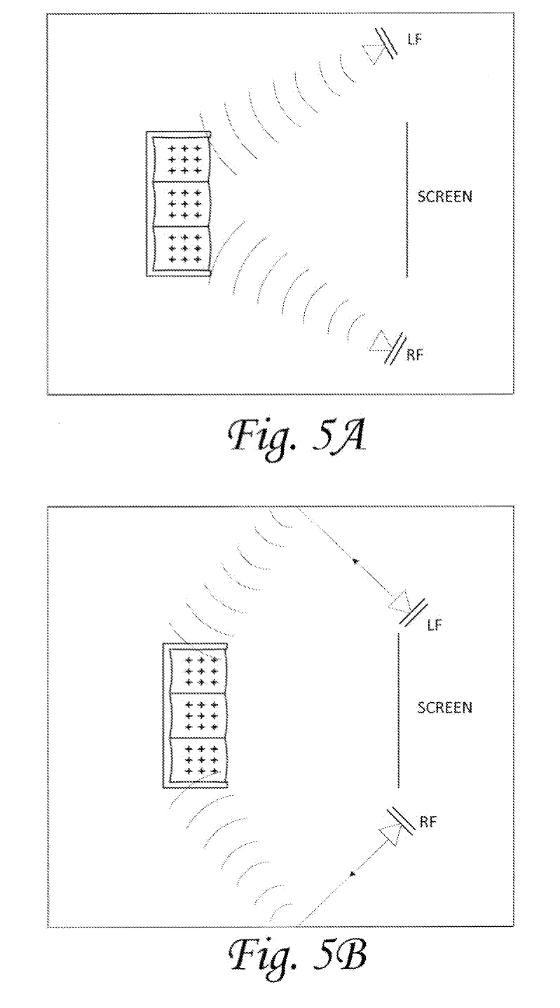

FIGS. 5A and 5B are diagrams illustrating example implementations of the multidimensional audio system in accordance with embodiments of the systems and methods described herein. Referring now to FIG. 5A, in the illustrated example, two parametric emitters are illustrated as being included in the system, left front and right front ultrasonic emitters, LF and RF, respectively. The left and right emitters are placed such that the sound is directed toward the left and right ears, respectively, of the listener or listeners of the video game or other program content. Alternative emitter positions can be used, but positions that direct the sound from each ultrasonic emitter LF, RF, to the respective ear of the listener(s) all spatial imagery as described herein.

In the example of FIG. 5B, the ultrasonic emitters LF, RF are placed such that the ultrasonic frequency emissions are directed at the walls (or other reflective structure) of the listening environment. When the parametric sound column is reflected from the wall or other surface, a virtual speaker or sound source is created. This is more fully described in U.S. Pat. Nos. 7,298,853, and 6,577,738 which are incorporated herein by reference in their entirety. As can be seen from the illustrated example, the resultant audio waves are directed toward the ears of the listener(s) at the determined seating position.

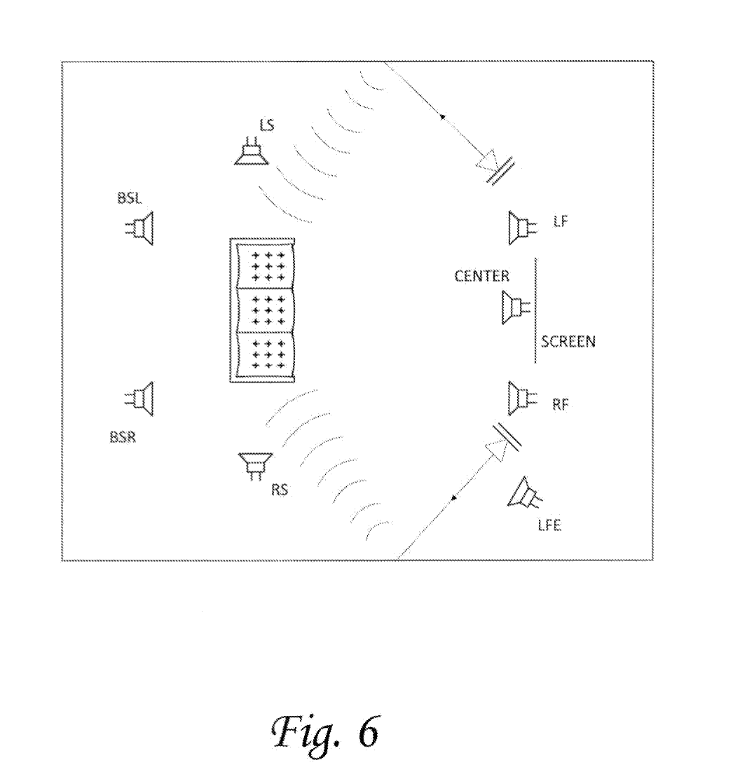

In various embodiments, the ultrasonic emitters can be combined with conventional speakers in stereo, surround sound or other configurations. FIG. 6 is a diagram illustrating an example implementation of the multidimensional audio system in accordance with another embodiment of the systems and methods described herein. Referring now to FIG. 6, in this example, the ultrasonic emitter configuration of FIG. 5B is combined with a conventional 7.1 surround sound system. As would be apparent to one of ordinary skill in the art after reading this description, the configuration of FIG. 5A can also be combined with a conventional 7.1 surround sound system. Although not illustrated, in another example, an additional pair of ultrasonic emitters can be placed to reflect a ultrasonic carrier audio signal from the back wall of the environment, replacing the conventional rear speakers.

In some embodiments, the emitters can be aimed to be targeted to a given individual listener's ears in a specific listening position in the room. This can be useful to enhance the effects of the system. Also, consider an application where one individual listener of a group of listeners is hearing impaired. Implementing hybrid embodiments (such as the example of FIG. 6) can allow the emitters to be targeted to the hearing impaired listener. As such, the volume of the audio from the ultrasonic emitters can be adjusted to that listener's elevated needs without needing to alter the volume of the conventional audio system. Where a highly directional audio beam is used from the ultrasonic emitters and targeted at the hearing impaired listener's ears, the increased volume from the ultrasonic emitters is not heard (or is only detected at low levels) by listeners who are not in the targeted listening position.

In various embodiments, the ultrasonic emitters can be combined with conventional surround sound configurations to replace some of the conventional speakers normally used. For example, the ultrasonic emitters in FIG. 6 can be used as the LS, RS speaker pair in a Dolby 5.1, 6.1, or 7.1 surround sound system, while conventional speakers are used for the remaining channels. As would be apparent to one of ordinary skill in the art after reading this description, the ultrasonic emitters may also be used as the back speakers BSC, BSL, BSR in a Dolby 6.1 or 7.1 configuration.

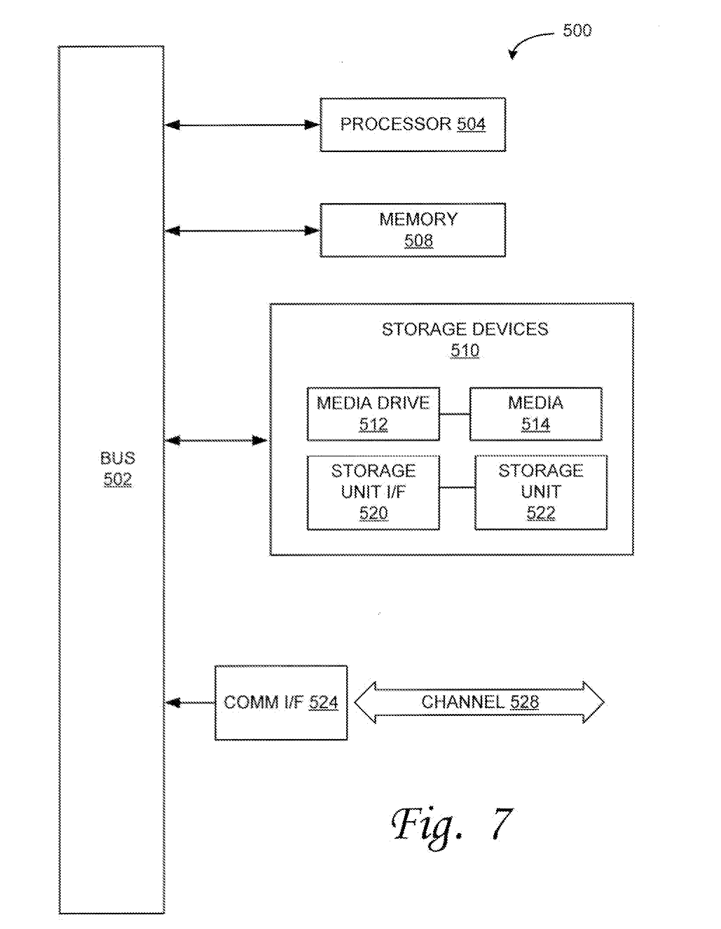

Although embodiments are described herein using a pair of ultrasonic emitters, other embodiments can be implemented using more than two emitters.

Where components or modules of the invention are implemented in whole or in part using software, in one embodiment, these software elements can be implemented to operate with a computing or processing module capable of carrying out the functionality described with respect thereto. One example computing module is shown in more detail in FIG. 7. Various embodiments are described in terms of this example-computing module 500. After reading this description, it will become apparent to a person skilled in the relevant art how to implement the invention using other computing modules or architectures.

Referring now to FIG. 7, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, and storage devices such as storage unit 520, and media 514. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described In terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of producing multi-dimensional parametric audio, comprising:
determining a desired spatial position of an audio component relative to a predetermined listening position;
processing the audio component for a predetermined number of output channels, wherein the step of processing the audio component comprises determining the appropriate phase, delay, and gain values for each output channel so that the audio component is created at the desired apparent spatial position relative to the listening position;
encoding two or more output channels of the audio component with the determined phase, delay, and gain values for each output channel; and
modulating the encoded output channels onto respective ultrasonic carriers for emission via a predetermined number of ultrasonic emitters.

2. The method of claim 1, wherein the step of processing the audio component further comprises determining echo, reverb, flange, and phasor values and the encoding step further comprises encoding two or more output channels with the determined echo, reverb, flange, and phasor values.

3. The method of claim 1, wherein the step of processing the audio component further comprises determining the appropriate phase, delay, and gain values for each output channel based on a predetermined location of the each of the predetermined number of ultrasonic emitters.

4. The method of claim 2, wherein the step of processing the audio component further comprises determining the appropriate phase, delay, and gain values for each output channel based on a predetermined location of the each of the predetermined number of ultrasonic emitters.

5. The method of claim 3, further comprising the step of receiving an encoded audio source comprising an audio component, wherein the audio source is encoded with component positioning information that relates to the spatial position of the audio component.

6. The method of claim 5, wherein the encoded audio source comprises a plurality of audio components and is encoded with information that relates to the spatial position of each audio component of the plurality of audio components and further comprising the step of decoding the encoded audio source to obtain each audio component of the plurality of audio components and the information that relates to the spatial position of each audio component.

7. The method of claim 5, wherein the encoded audio source comprises a plurality of surround sound channels and is encoded with information identifying each surround sound channel of the plurality of surround sound channels of a surround sound configuration and further comprising the step of decoding the encoded audio source to obtain each surround sound channel of the plurality of surround sound channels.

8. The method of claim 7, wherein the surround sound configuration comprises six channels corresponding to five speakers and one subwoofer or low frequency speaker.

9. The method of claim 7, wherein the surround sound configuration comprises seven channels corresponding to six speakers and one subwoofer or low frequency speaker.

10. The method of claim 7, wherein the surround sound configuration comprises eight channels corresponding to seven speakers and one subwoofer or low frequency speaker.

11. The method of claim 7, wherein each surround sound channel of the plurality of surround sound channels comprises an audio component and is encoded with positioning information that relates to the spatial position of the audio component within that channel.

12. The method of claim 11, further comprising the step of decoding each surround sound channel to obtain the audio component and the position information that relates to the spatial position of the audio component within that channel.

13. The method of claim 12, wherein the step of determining the desired spatial position comprises determining the desired spatial positioning of an audio component based on a predetermined listening position, the specific surround sound channel comprising the audio component, and the positioning information of the audio component within the surround sound channel.

14. The method of claim 11, wherein each surround sound channel comprises a plurality of audio components, wherein the determining, processing, and encoding steps are applied to each audio component of the plurality of audio components.

15. The method of claim 14, further comprising the step of combining each encoded output channel of each audio component of the plurality of audio components into an encoded output bitstream for each output channel and wherein the step of outputting comprises outputting the encoded output bitstreams for each output channel to a predetermined number of ultrasonic emitters.

16. The method of claim 1, wherein the predetermined number of output channels is the same number as the predetermined number of ultrasonic emitters.

17. The method of claim 16, wherein the predetermined number of output channels and predetermined number of ultrasonic emitters is two.

18. The method of claim 1, wherein the wherein the audio component comprises a component, wherein a component comprises at least one of a frequency component, a Dolby channel, and an audio object.

19. A multi-dimensional parametric audio system, comprising:
an audio source comprising an audio component;
an audio encoder;
a predetermined number of ultrasonic emitters;
wherein the parametric audio encoder is configured to perform the steps of:
determining a desired spatial position of an audio component relative to a predetermined listening position;
processing the audio component into a predetermined number of output channels, wherein the step of processing the audio component comprises determining the appropriate phase, delay, and gain values for each output channel so that the audio component is created at the desired spatial position relative to the listening position;
encoding two or more output channels of the audio component with the determined phase, delay, and gain values previously determined for each output channel; and
outputting the encoded output channels to a predetermined number of ultrasonic emitters.

20. The system of claim 19, wherein the step of processing the audio component further comprises determining echo, reverb, flange, and phasor values and the encoding step further comprises encoding two or more output channels with the determined echo, reverb, flange, and phasor values.

21. The system of claim 19, wherein the step of processing the audio component further comprises determining the appropriate phase, delay, and gain values for each output channel based on a predetermined location of the each of the predetermined number of ultrasonic emitters.

22. The system of claim 20, wherein the step of processing the audio component further comprises determining the appropriate phase, delay, and gain values for each output channel based on a predetermined location of the each of the predetermined number of ultrasonic emitters.

23. The system of claim 21, further comprising the step of receiving an encoded audio source comprising an audio component, wherein the audio source is encoded with positioning information that relates to the spatial position of the audio component.

24. The system of claim 23, wherein the encoded audio source comprises a plurality of audio components and is encoded with information that relates to the spatial position of each audio component of the plurality of audio components.

25. The system of claim 23, wherein the encoded audio source comprises a plurality of surround sound channels and is encoded with information identifying each surround sound channel of the plurality of surround sound channels of a surround sound configuration and further comprising the step of decoding the encoded audio source to obtain each surround sound channel of the plurality of surround sound channels.

26. The system of claim 25, wherein the surround sound configuration comprises six channels corresponding to five speakers and one subwoofer or low frequency speaker.

27. The system of claim 25, wherein the surround sound configuration comprises seven channels corresponding to six speakers and one subwoofer or low frequency speaker.

28. The system of claim 25, wherein the surround sound configuration comprises eight channels corresponding to seven speakers and one subwoofer or low frequency speaker.

29. The system of claim 25, wherein each surround sound channel of the plurality of surround sound channels comprises an audio component and is encoded with positioning information that relates to the spatial position of the audio component within that channel.

30. The system of claim 29, further comprising the step of decoding each surround sound channel to obtain the audio component and the position information that relates to the spatial position of the audio component within that channel.

31. The system of claim 30, wherein the step of determining the desired spatial position comprises determining the desired spatial positioning of an audio component based on a predetermined listening position, the specific surround sound channel comprising the audio component, and the positioning information of the audio component within the surround sound channel.

32. The system of claim 29, wherein each surround sound channel comprises a plurality of audio components, wherein the determining, processing, and encoding steps are applied to each audio component of the plurality of audio components.

33. The system of claim 32, further comprising the step of combining each encoded output channel of each audio component of the plurality of audio components into an encoded output bitstream for each output channel and wherein the step of outputting comprises outputting the encoded output bitstreams for each output channel to a predetermined number of ultrasonic emitters.

34. The system of claim 19, wherein the predetermined number of output channels is the same number as the predetermined number of ultrasonic emitters.

35. The system of claim 34, wherein the predetermined number of output channels and predetermined number of ultrasonic emitters is two.

36. The system of claim 19, wherein the system is combined with a conventional surround sound system to create a hybrid conventional surround and ultrasonic sound system.
